(19) United States
(12) Patent Application Publication
(10) Pub. No.: US 2023/0386058 A1
(43) Pub. Date: Nov. 30, 2023

(54) OBJECT INFORMATION GENERATION SYSTEM, OBJECT INFORMATION GENERATION METHOD, AND OBJECT INFORMATION GENERATION PROGRAM

(71) Applicant: Panasonic Intellectual Property Management Co., Ltd., Osaka (JP)

(72) Inventors: Yusuke YUASA, KYOTO (JP); Shigeru SAITOU, KYOTO (JP); Yugo NOSE, KYOTO (JP); Shota YAMADA, SHIGA (JP); Shinzo KOYAMA, OSAKA (JP); Masayuki SAWADA, OSAKA (JP); Yutaka HIROSE, KYOTO (JP); Akihiro ODAGAWA, OSAKA (JP)

(21) Appl. No.: 18/448,712

(22) Filed: Aug. 11, 2023

Related U.S. Application Data
(63) Continuation of application No. PCT/JP2022/001976, filed on Jan. 20, 2022.

(30) Foreign Application Priority Data
Feb. 15, 2021 (JP) 2021-021596

(51) Int. Cl. G06T 7/55; G06T 7/11; G06T 7/73; G06T 11/00

(52) U.S. Cl. CPC G06T 7/55; G06T 7/11; G06T 7/73; G06T 11/00; G06T 2207/20132; G06T 2207/10028

(57) ABSTRACT

In an object information generation system, an imaging unit is configured to capture a plurality of segment images respectively corresponding to a plurality of distance segments dividing a target space. In a signal processor, the object region extraction unit extracts, from a plurality of segment images, an object region that is a pixel region including an image of the object. An object information generation unit determines, for the object region, a window in which calculation-target pixels are cut out, and generates distance information of the object by calculation using information of a plurality of pixels in the window for two or more segment images.

### CROSS-REFERENCE TO RELATED APPLICATIONS

This is a continuation of International Application No. PCT/JP2022/001976 filed on Jan. 20, 2022, which claims priority to Japanese Patent Application No. 2021-021596 filed on Feb. 15, 2021. The entire disclosures of these applications are incorporated by reference herein.

### BACKGROUND

The present disclosure relates to an object information generation system configured to generate distance information of an object present in a target segment, from a plurality of segment images dividing a target space at certain distances.

PCT International Publication No. WO 2019/181518 discloses a distance measuring device capable of improving resolution of a measured distance. In this distance measuring device, a distance measuring unit calculates the distance to a target object based on a period taken from when a measurement wave is transmitted from a wave transmitter to when the measurement wave is received at a wave receiver. When the target object exists across an anterior distance section and a continuous posterior distance section among a plurality of distance sections dividing the measurable distance, the distance measuring unit calculates the distance to the target object based on the amount of waves received in a period corresponding to the anterior distance section and the amount of waves received in a period corresponding to the posterior distance section.

### SUMMARY

PCT International Publication No. WO 2019/181518 improves accuracy in calculation of distance values to a target object by using a ratio of received light signal amounts corresponding to distance sections adjacent to each other for each pixel. However, the technique of PCT International Publication No. WO 2019/181518 requires, for actual use, a plurality of measurements for the same pixel in order to remove noise. This leads to a problem that calculation of a distance value requires time.

The present disclosure was made in view of the above problem, and it is an objective of the present disclosure to enable generation of distance information of an object in a short period of time, in an object information generation system.

An object information generation system according to an aspect of the present disclosure includes: an imaging unit configured to capture a plurality of segment images respectively corresponding to a plurality of distance segments dividing a target space; and a signal processor configured to process the plurality of segment images to generate information related to an object present in the target space. The signal processor includes: an object region extraction unit configured to extract, from the plurality of segment images, an object region that is a pixel region including an image of an object; and an object information generation unit configured to determine, for the object region, one or more windows in which calculation-target pixels are cut out, and generate distance information of the object by calculation using information of a plurality of pixels in the window for two or more segment images of the plurality of segment images.

The present disclosure enables generation of highly accurate distance information of an object in a short period of time, in an object information generation system.

### BRIEF DESCRIPTION OF THE DRAWINGS

FIG. 1 is a diagram showing a configuration of an object information generation system according to an embodiment.

FIG. 2 is a diagram schematically showing the segment image generation by an imaging unit.

FIG. 3A is a diagram showing a scene in which a person is present in a target space and an arrival pattern of reflected light reflected by the person, and FIG. 3B is a diagram showing an exemplary segment image captured.

FIG. 4 is a diagram showing an exemplary signal level of each distance segment for pixels capturing an image of a person.

FIG. 5A is a diagram showing a scene in which a person is present in a target space, and FIG. 5B is an exemplary window setting.

FIG. 6 is a flowchart of an exemplary object information generation method according to the embodiment.

FIG. 7A is a flowchart of an object region extraction step, and FIG. 7B is a flowchart of an object information generation step.

FIG. 8A is a diagram showing a scene in which a plurality of objects are present in a target space, and FIG. 8B is a diagram showing an exemplary window setting.

### DETAILED DESCRIPTION

### Summary

An object information generation system according to an aspect of the present disclosure includes: an imaging unit configured to capture a plurality of segment images respectively corresponding to a plurality of distance segments dividing a target space; and a signal processor configured to process the plurality of segment images to generate information related to an object present in the target space. The signal processor includes: an object region extraction unit configured to extract, from the plurality of segment images, an object region that is a pixel region including an image of an object; and an object information generation unit configured to determine, for the object region, one or more windows in which calculation-target pixels are cut out, and generate distance information of the object by calculation using information of a plurality of pixels in the window for two or more segment images of the plurality of segment images.

In this object information generation system, the imaging unit captures a plurality of segment images respectively corresponding to a plurality of distance segments dividing the target space. In the signal processor, the object region extraction unit extracts, from a plurality of segment images, an object region that is a pixel region including an image of the object. Then, the object information generation unit determines, for the object region, a window in which calculation-target pixels are cut out, and generates the distance information of the object by calculation using information of a plurality of pixels in the window for two or more segment images. Using the information of the plurality of pixels enables removal of noise, and there is no longer a need to perform measurement a plurality of times for the same pixel to remove the noise. Further, since calculation-target pixels are those in the window determined for the object region, the amount of calculation is significantly reduced as compared to a technique of targeting all the pixels for calculation. Therefore, the distance information can be generated in a short time.

Further, the object information generation unit may set a plurality of the windows different from each other for the object region, and generate the distance information of the object by using each of the windows.

This makes it possible to easily generate distance information of a plurality of portions of the object.

Further, the object information generation unit may generate information related to a shape of the object by using the distance information of the object, the distance information being generated by using each of the windows.

This way, information related to the shape of the object can be generated from the distance information of a plurality of portions of the object.

Alternatively, the object information generation unit may determine separability of the object region by using the distance information of the object, the distance information being generated by using each of the windows.

This allows determination of the separability of the object region, based on the distance information of a plurality of positions in the object region.

Further, the object information generation unit may determine the number of pixels for use in the calculation, according to a distance of a distance segment corresponding to a calculation-target segment image.

This way, it is possible to reduce variations in the calculation amount and the calculation accuracy caused by the distance to the object.

Further, the signal processor may include an image synthesizer configured to generate a distance image in which a distance value is assigned to each pixel, by using the plurality of segment images, and the object region extraction unit may extract the object region from the distance image.

This way, the object region can be extracted by using the distance image.

Further, the signal processor may include an image synthesizer configured to generate a distance image in which a distance value is assigned to each pixel, by using the plurality of segment images, and the object information generation unit may generate the distance information of the object by using the distance image.

This way, the distance information of the object can be generated by using the distance image.

An object information generation method according to an aspect of the present disclosure is a method of generating information related to an object present in a target space by processing a plurality of segment images respectively corresponding to a plurality of distance segments dividing the target space, the method including: extracting, from the plurality of segment images, an object region that is a pixel region including an image of an object; determining, for the object region, one or more windows in which a plurality of calculation-target pixels are cut out; and generating distance information of the object by calculation using information of a plurality of pixels in the window for two or more segment images of the plurality of segment images.

According to this object information generation method, an object region that is a pixel region including an image of an object is extracted from a plurality of segment images respectively corresponding to a plurality of distance segments dividing a target space. Then, for the object region, a window in which calculation-target pixels are cut out is determined, and distance information of the object is generated by calculation using information of a plurality of pixels in the window for two or more segment images. Using the information of the plurality of pixels enables removal of noise, and there is no longer a need to perform measurement a plurality of times for the same pixel to remove the noise. Further, since calculation-target pixels are those in the window determined for the object region, the amount of calculation is significantly reduced as compared to a technique of targeting all the pixels for calculation. Therefore, the distance information can be generated in a short time.

Further, a program according to an aspect of the present disclosure causes a computer system including one or more processors to execute the object information generation method of the above-described aspect.

Now, embodiments will be described in detail with reference to the drawings. Unnecessarily detailed description may be omitted. For example, detailed description of already well-known matters or repeated description of substantially the same configurations may be omitted. This is to reduce unnecessary redundancy of the following description and to facilitate the understanding by those skilled in the art.

The accompanying drawings and the following description are provided for sufficient understanding of the present disclosure by those skilled in the art, and are not intended to limit the subject matter of the claims.

### 1. SUMMARY

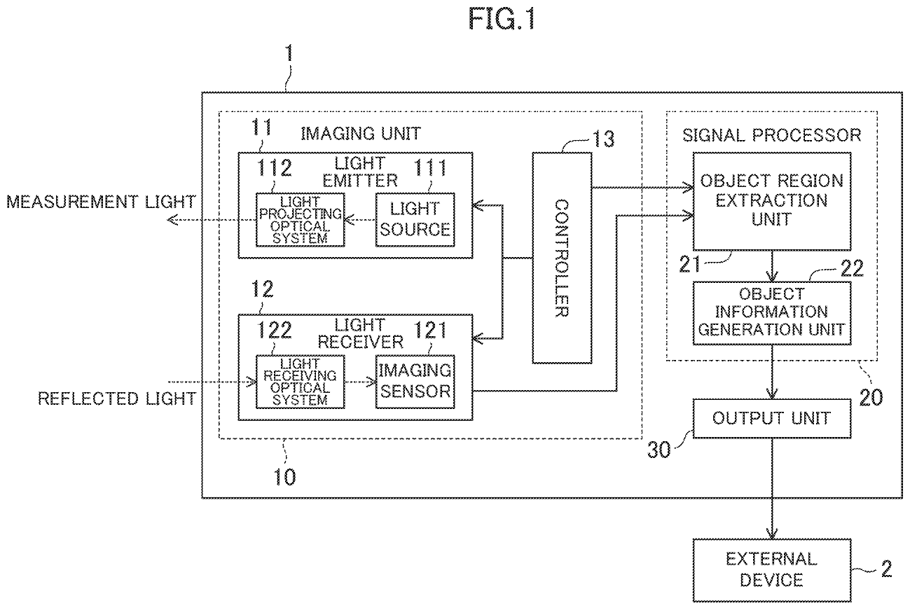

FIG. 1 is a block diagram showing a configuration of an object information generation system according to an embodiment. As illustrated in FIG. 1, an object information generation system 1 includes an imaging unit 10, a signal processor 20, and an output unit 30. The object information generation system 1 obtains information of the distance to an object by the time-of-flight (TOF) method and processes images generated. For example, the object information generation system 1 can be used for a monitoring camera that detects an object (person), a system that tracks a flow line of a person in a factory or a commercial facility to improve labor productivity or analyze purchase behavior of consumers, a system that is mounted on an automobile and detects an obstacle, and the like.

The imaging unit 10 includes a light emitter 11, a light receiver 12, and a controller 13. The imaging unit 10 is configured to be capable of emitting measurement light from the light emitter 11 to a target space, capturing reflected light reflected by an object present in the target space via the light receiver 12, measuring a distance to the object using the TOF method, and generating an image. The light emitter 11 is configured to project measurement light to the target space. The light receiver 12 is configured to receive reflected light reflected by an object present in the target space and generate images. The controller 13 is configured to perform light emission control of the light emitter 11 and light reception control of the light receiver 12. The controller 13 controls the light emitter 11 and the light receiver 12 so that the light receiver 12 generates a plurality of segment images corresponding to a plurality of distance segments dividing the target space.

The signal processor 20 is configured to process the plurality of segment images generated by the imaging unit 10 to generate information related to the object present in the target space. The signal processor 20 includes an object region extraction unit 21 and an object information generation unit 22. The object region extraction unit 21 is configured to extract an object region that is a pixel region including an image of the object, from the segment images generated by the imaging unit 10. The object information generation unit 22 is configured to generate information related to the object included in the object region extracted by the object region extraction unit 21.

The output unit 30 is configured to output object information generated by the signal processor 20 to an external device 2.

The object information generation system 1 of the present embodiment generates information including a distance value or a shape, for each object present in the target space, by using a plurality of pixels of the plurality of segment images. Accordingly, the object information generation system 1 of the present embodiment is capable of separating each of the objects present in the target space from one another in a depth direction. Further, the process of separating the objects in the depth direction can be executed at a high speed.

### 2. CONFIGURATION

### [2-1. Imaging Unit]

As described hereinabove, the imaging unit 10 includes the light emitter 11, the light receiver 12, and the controller 13. The imaging unit 10 is configured to be capable of emitting measurement light from the light emitter 11 to a target space, capturing reflected light reflected by an object present in the target space via the light receiver 12, measuring a distance to the object using the TOF method, and generating an image.

### [2-1-1. Light Emitter]

The light emitter 11 is configured to project measurement light to the target space. The light emitter 11 includes a light source 111 for projecting the measurement light to the target space. The measurement light is pulsed light. The measurement light has a single wavelength, a relatively short pulse width, and a relatively high peak intensity, in one preferred embodiment.

Further, considering the use in an urban area or the like where a person is present in the target space, the wavelength of the measurement light falls within a wavelength range of a near-infrared band hardly visible to humans and hardly affected by disturbance light from sunlight, in one preferred embodiment. In the present embodiment, the light source 111 is configured by a laser diode, for example, and outputs a pulse laser. The intensity of the pulse laser output from the light source satisfies the standard of class 1 or class 2 of the safety standards (JIS C 6802) of laser products. The light source 111 is not limited to the above-described configuration and may be a light-emitting diode (LED), a vertical cavity surface emitting laser (VCSEL), a halogen lamp, or the like. The measurement light may be in a wavelength range different from the near-infrared band. The light emitter 11 may further include a light projecting optical system 112 such as a lens that projects the measurement light to the target space.

### [2-1-2. Light Receiver]

The light receiver 12 is configured to receive reflected light reflected by an object present in the target space and generate images. The light receiver 12 includes an imaging sensor 121 including a plurality of pixels, and is configured to receive reflected light reflected by an object present in the target space and generate segment images. In each pixel, an avalanche photodiode is disposed. Other light detecting elements may be disposed in each pixel. The pixels are switchable between light exposure for receiving reflected light, and non-light exposure for receiving no reflected light. In the light exposure, the light receiver 12 outputs a pixel signal according to the reflected light received by the pixel. The signal level of the pixel signal corresponds to the number of pulses of light received by the pixel. The signal level of the pixel signal may be correlated to other characteristics of light, such as reflected light intensity.

The light receiver 12 may further include a light receiving optical system 122, such as a lens, which collects the reflected light on the light receiving surface of the imaging sensor. The light receiver 12 may further include a filter that blocks or transmits light of a specific frequency. This enables obtaining of information related to the frequency of the light.

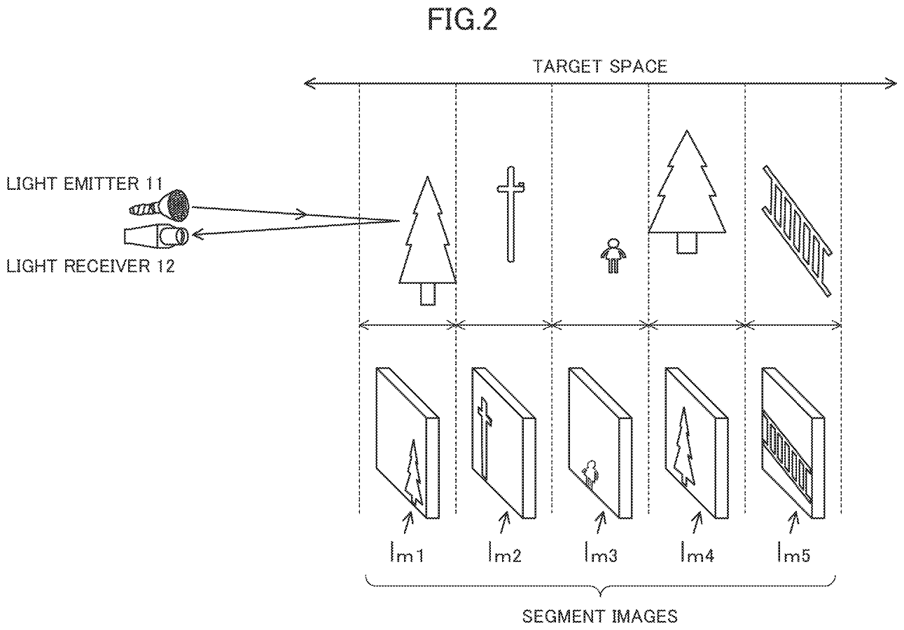

FIG. 2 is a diagram schematically showing how images are generated by the light receiver 12. For each of one or more distance segments dividing the target space, if there is an object in the distance segment, the light receiver 12 generates a detection signal based on reflected light reflected from the object in each pixel, and generates and outputs segment images 1 m1 to 1 m5. The distance to the deepest portion of the target space is determined according to a period of time taken from when the light emitter 11 emits the measurement light to when the imaging sensor 121 performs the last exposure operation. The distance to the deepest portion of the target space is not particularly limited, but is several tens of centimeters to several tens of meters, for example. In the object information generation system 1, the setting of the distance to the deepest portion of the target space may be fixed or may be variable. In the present embodiment, the setting is assumed to be variable.

### [2-1-3. Controller]

The controller 13 is configured to perform the light emission control of the light emitter 11 and the light reception control of the light receiver 12. The controller 13 is configured, for example, by a microcomputer including a processor and a memory. The processor functions as the controller 13 by executing the program as needed. The program may be recorded in the memory in advance, or may be provided through an electric line such as the Internet or from a non-transitory recording medium such as a memory card. Furthermore, a unit, such as a keyboard, which receives settings may be provided so that a setting be received from an operator to change the control method. When controlling the light emission by the light emitter 11, the controller 13 controls the timing of outputting light from the light source 111, the pulse width of the light output from the light source 111, and other factors. When controlling the light reception by the light receiver 12, the controller 13 controls, for example, the operation timing of transistors in the pixels, thereby controlling the timing of exposure (exposure timing), the exposure width (exposure period), and other factors. The exposure timing and the exposure period may be the same for all pixels or may be different depending on the pixels.

Specifically, the controller 13 causes the light source 111 to output the measurement light a plurality of times within a period corresponding to a single distance measurement. The number of times the measurement light is output within a single measurement cycle is the same as the number of the plurality of distance segments into which the target space is divided by the object information generation system 1. A single measurement cycle includes a plurality of measurement periods. The number of measurement periods in a single measurement cycle is the same as the number of the plurality of distance segments. A single measurement period corresponds to a distance segment out of the plurality of distance segments on a one-to-one basis. The time length of each divided period is, for example, 10 ns.

The controller 13 causes the light source 111 to emit light in a first divided period out of the measurement periods. The light emission period of a single light emission may have the same time length as the divided period or may have a different time length from the divided period.

In addition, the controller 13 causes the light receiver 12 to be exposed in any of the plurality of divided periods in each measurement period. Specifically, the controller 13 sequentially shifts the timing of exposing the light receiver 12 one by one from the first divided period to an n-th divided period for each measurement period. That is, in a single measurement cycle, the light receiver 12 is exposed in all the plurality of divided periods. The exposure period of a single exposure may have the same time length as the divided period or may have a different time length from the divided period. Further, the timing of exposing the light receiver 12 may be shifted in another order, instead of shifting the timing sequentially from the first divided period to the n-th divided period.

That is, light emission and exposure take place once in each measurement period, and a time difference between the light emission timing and the exposure timing is different in each measurement period. Therefore, where the number of the plurality of distance segments is n, the number of times light emission takes place and the number of times exposure takes place within a single measurement cycle are n. Where the number of measurement cycles per second is f, the number of times light emission takes place per second and the number of times exposure takes place per second are f×n.

The light receiver 12 can receive the reflected light reflected by the object only during the period of exposure. The time taken from emission of light from the light emitter 11 to reception of the reflected light at the light receiver 12 changes according to the distance from the object information generation system 1 to the object. Where the distance from the object information generation system 1 to the object is d and the speed of light is c, the reflected light reaches the light receiver 12 after time t=2d/c from emission of the light from the light emitter 11. Therefore, the distance to the object can be calculated based on the time taken from emission of light from the light emitter 11 to reception of the reflected light at the light receiver 12. Further, the measurable distance is n×Ts×c/2 based on the time length Ts of the divided period.

The controller 13 repeats the measurement cycle p times, and controls the light receiver 12 so that, of the pixel signals generated in the measurement cycles, signals generated by exposure during the same divided period are integrated for each pixel and are output as a pixel of a segment image corresponding to each divided period. “p” is an integer of 1 or more. In a single measurement cycle of the present embodiment, light emission and exposure take place once in each divided period. Therefore, a maximum value of each pixel signal is 1, considering that the signal level of each pixel signal corresponds to the number of pulses received. That is, if the measurement cycle is repeated p times and the pixel signals are integrated, the signal level corresponding to each pixel is equal to p at the maximum. In the present embodiment, the signal levels of the pixel signals of all the pixels in an image are p at the maximum. An image may be generated by including a measurement cycle in which one or more divided periods perform no exposure so that the maximum value of the signal level changes in each divided period.

### [2-2. Signal Processor]

The signal processor 20 is configured to generate information related to the object, from the plurality of segment images generated by the imaging unit 10. The signal processor 20 includes the object region extraction unit 21 and the object information generation unit 22.

### [2-2-1. Object Region Extraction Unit]

The object region extraction unit 21 is configured to extract an object region that is a pixel region including an image of the object, from the segment images generated by the imaging unit 10.

The object region extraction unit 21 is configured, for example, by a computer system including a processor and a memory. The object region extraction unit 21 functions by the processor executing a suitable program. The program may be recorded in the memory in advance, or may be provided through an electric communication line such as the Internet or from a non-transitory recording medium such as a memory card.

More specifically, for example, the processor performs processing on an image output from the light receiver 12, and the memory retains the image and a result of the processing by the processor (information related to the extracted object region). The information retained in the memory is output to the object information generation unit 22 at predetermined timing. The information of the object region retained in the memory may be in the form of an image, may be converted into a form such as a run length code or a chain code, or may be in another form.

For example, the object region extraction unit 21 extracts, as an object region, a region where pixels having a high signal level are present at a high density, in each of the plurality of segment images. It should be noted, however, that the method of the object region extraction process is not limited to this. For example, signal levels of the same pixels may be added across all the segment images to generate a luminance image, and a region where pixels having a high signal level are present at a high density in the luminance image may be extracted as an object region.

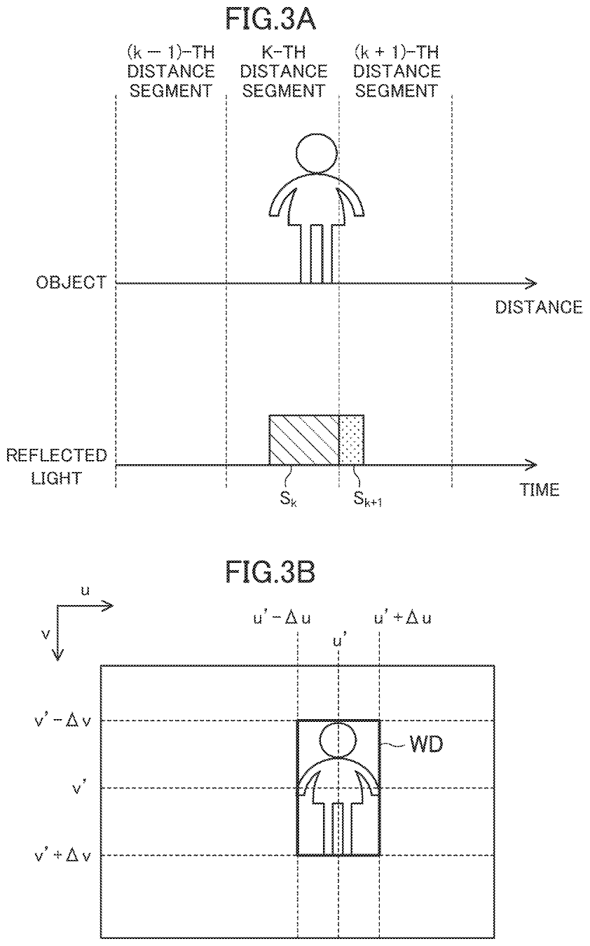

FIG. 3A is a diagram showing a scene in which a person is present in a target space and an arrival pattern of reflected light reflected by the person. FIG. 3B shows an exemplary segment image captured. In the scene of FIG. 3A, a person exists across the border between the k-th distance segment and the (k+1)-th distance segment. For example, as shown in FIG. 3B, a window WD in which calculation-target pixels are cut out is set for pixel (u′, v′) in an image region where a horizontal coordinate is u and a vertical coordinate is v. The size of the window WD is 2Δu in width and 2Δv in height. The function den(u, v, t) is set as the following Equation (1), where the signal level of a pixel (u, v) in the k-th distance segment is Sk.

$$\begin{matrix}[ Math 1 ] & \\ den ( u , v , k ) = \frac{{\sum }_{u = u - Δ u}^{u + Δ u} {\sum }_{v = v - Δ v}^{v + Δ v} {S}_{k}}{4 p Δ u Δ v} & ( 1 )\end{matrix}$$

A threshold value Th that is 0≤Th<1 is prepared, and pixels (u, v) that satisfy den(u, v, t)>Th are determined as a candidate region containing an image of an object. Candidate regions connected to one another in any one of the eight adjacent directions are extracted as a single object region.

A process may be inserted before or after the calculation of den(u, v, t) for the purpose of limiting the object region or increasing the sensitivity of the object region extraction process. For example, it is possible to insert, before measurement, a process in which: segment images each with the background are generated; the segment images are stored as reference segment images; a reference segment image corresponding to a segment image generated is selected before calculating den(u, v, t); and for each pixel, the signal level of the reference segment image is subtracted from the signal level of the segment image generated. The process of subtracting the signal level of the reference segment image from the signal level of the segment image for each pixel corresponds to a process of removing the background image from the segment image to be subjected to object region extraction.

Further, for example, a filtering technique such as morphological operations may be used, after calculation of den(u, v, t) and extraction of candidate regions, to exclude a noise-attributed candidate region or facilitate connection of candidate regions close to one another. The process before or after the extraction of the object region is not limited to the above, and other techniques may be used.

The method of extracting the candidate region in the segment image is not necessarily limited to Equation (1), and other calculation methods may be used.

### [2-2-2. Object Information Generation Unit]

The object information generation unit 22 is configured to generate information related to the object included in the object region extracted by the object region extraction unit 21.

The object information generation unit 22 is configured, for example, by a computer system including a processor and a memory. The object information generation unit 22 functions by the processor executing a suitable program. The program may be recorded in the memory in advance, or may be provided through an electric communication line such as the Internet or from a non-transitory recording medium such as a memory card.

More specifically, for example, the processor executes an object information generation process, and the memory retains object information generated. The object information retained in the memory is output to the output unit 30 at predetermined timing. The object information retained in memory may be an image, or it may be in another format such as a vector or string of text.

For example, for each of the objects included in an object region, the object information generation unit 22 generates information related to three-dimensional position coordinates of the center, area, and three-dimensional shape, and outputs as an object information vector with dimensions equal to the number of pieces of the information. In the present embodiment, one object region is determined to correspond to an image of one object for the sake of simplicity. It should be noted, however, that one object region does not necessarily have to be determined to correspond to an image of one object, and it may be determined that a plurality of objects are present in one object region as in a variation which will be described later. Alternatively, it may be determined that a plurality of object regions correspond to one object.

Further, the object information generation unit 22 may generate other characteristics, instead of generating the object information as described above. For example, the moving direction and the speed of an object in a three-dimensional space may be generated through a process between a plurality of measurement cycles. Alternatively, a two-dimensional feature such as a moment of the image of an object or an aspect ratio of a circumscribed rectangle of the image of the object may be generated. In a case where it is determined that a plurality of objects are present in the target space, relation among the objects such as relative positions may be generated. Further, the object information generation unit 22 may output the object information generated in another format, instead of outputting the same as a vector of each object. Further, it is not necessary to output object information of the same type in all of the measurement cycles.

The object information generation unit 22 of the present embodiment generates the three-dimensional position coordinates of the center of the object by using a plurality of pixels in a plurality of segment images.

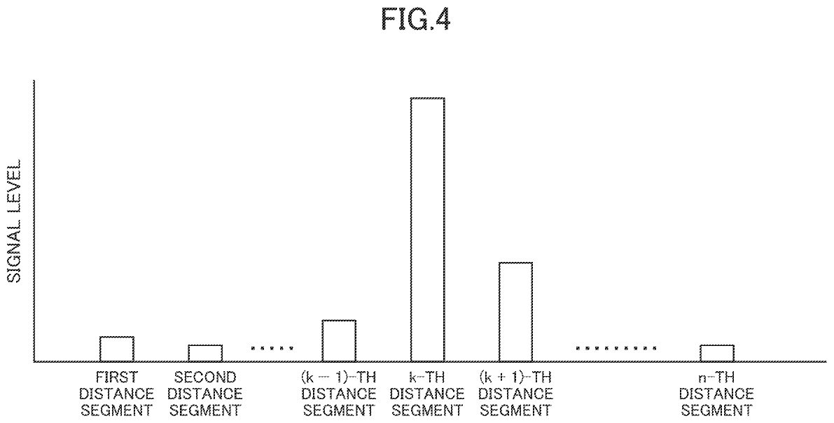

FIG. 4 is a diagram showing exemplary signal levels of the first to n-th distance segments in pixels capturing an image of the person shown in FIG. 3A. In the example of FIG. 3A, the person exists across the border between the k-th distance segment and the (k+1)-th distance segment. Therefore, as illustrated in FIG. 4, the signal levels of the pixels corresponding to the image of the person are maximum in the k-th distance segment, followed by large values in the (k+1)-th distance segment. By using the ratio of these signal levels, the distance to the person is obtainable in units smaller than the size of the distance segment. However, in practice, the relationship of the magnitudes of the signal levels in distance segments may be reversed or the ratio of the signal levels may change due to noise or local characteristics such as an irregular pattern of a surface of the object. Therefore, the method using the ratio of the signal levels of a single pixel may be insufficient as information representing an object.

The object information generation unit 22 generates a distance by using signal levels of three distance segments including a likely distance segment where the center of the object is present in the middle and its front and rear distance segments. The likely distance segment k where the center of the object is present is calculated, for example, by the following Equation (2).

$$\begin{matrix}[ Math 2 ] & \\ k = {argmax}_{n ∈ ( 1 , 2 , 3 , … , n \}} \frac{{\sum }_{u = u - Δ u}^{u + Δ u} {\sum }_{v = v - Δ v}^{v + Δ v} {S}_{n}}{4 p Δ u Δ v} & ( 2 )\end{matrix}$$

The method of calculating the distance segment k is not limited to Equation (2), and another calculation method may be implemented.

Next, the distance to the center of the object is calculated by the following Equation (3), using the signal levels of the k-th distance segment, and the (k−1)-th distance segment and (k+1)-th distance segment at the front and rear of the k-th distance segment.

$$\begin{matrix}[ Math 3 ] & \\ d ( {u}^{′} , {v}^{′} ) = \frac{{\sum }_{n = k - 1}^{k + 1} {\sum }_{u = {u}^{′} - Δ u}^{{u}^{′} + Δ u} {\sum }_{v = {v}^{′} - Δ v}^{{v}^{′} + Δ v} {S}_{n} {d}_{n}}{{\sum }_{n = k - 1}^{k + 1} {\sum }_{u = {u}^{′} - Δ u}^{{u}^{′} + Δ u} {\sum }_{v = {v}^{′} - Δ v}^{{v}^{′} + Δ v} {S}_{n}} & ( 3 )\end{matrix}$$

It should be noted that the distance to the middle of the k-th distance segment is dk. The calculations described above allow generation of distance values in units smaller than the size of the distance segment, allowing objects present in the same segment image to be separated in the depth direction. In Equations (2) and (3), the rectangular window WD shown in FIG. 3B is used as a window in which calculation-target pixels are cut out. The calculation of Equation (3) enables measurement in distance units of about 1/4ΔuΔv times in the same number of measurement cycles, as compared with the technique described in PCT International Publication No. WO 2019/181518.

Equation (3) does not necessarily have to be used for calculation of the distance to the center of the object. For example, more segment images may be used instead of the segment images corresponding to the three distance segments including the k-th distance segment in the middle and its front and rear distance segments. Alternatively, the calculation may be performed by using only two segment images corresponding to two distance segments (i.e., the k-th distance segment and the (k+1)-th distance segment) where a person exists across the border therebetween.

Further, the above Equations (1) to (3) use the rectangular window WD for use as a window in which calculation-target pixels are cut out. Such a window in which calculation-target pixels are cut out may have, for example, a different shape such as a shape close to a circle or a frame-like shape.

Further, instead of using, for calculation, all the pixels in the window, the pixels in the window may be reduced and subjected to calculation. By reducing the pixels in the window and subjecting the remaining pixels to the calculation, the amount of calculation can be reduced without losing global information of the object region.

The number of pixels used for calculation may be determined according to the distance dk of the distance segment corresponding to the segment image to be calculated. For example, the pixels in the window may be reduced so that the number of calculation-target pixels is proportional to dk\hat{ }2. This way, it is possible to reduce variations in the calculation amount and the calculation accuracy caused by the distance to the object, in the process of calculating distances to the objects that are similar in size.

Furthermore, instead of applying a window of a fixed shape, such as a circumscribed rectangle, to all object regions, a window may have a shape identical to the object image or may have a shape cutting out a portion of the object image.

The object information generation unit 22 is capable of calculating a distance of a portion of the object other than its center, by using the above-described Equation (3) or the like. To calculate a distance to a portion of the object other than its center, the distance is calculated, for example, by cutting out, into a window, a portion around the coordinates near the center of the calculation-target portion, instead of the coordinates near the center of the object.

Further, the object information generation unit 22 generates information related to the three-dimensional shape of the object. The present embodiment determines whether the object has a recessed shape, protruding shape, or a flat surface in the depth direction as the information related to three-dimensional shape of the object. The object information generation unit 22 sets a plurality of windows for the object region and generates information related to the shape of the object based on the distance information of the object obtained by using the windows.

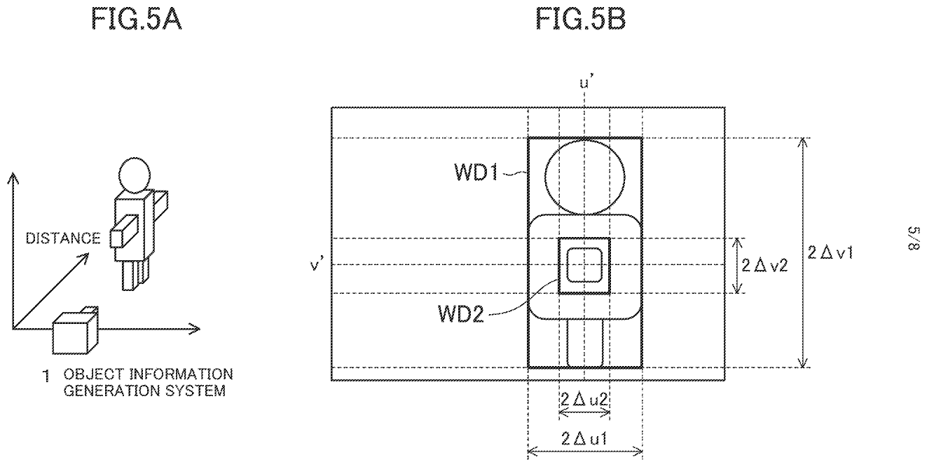

FIG. 5 is a diagram showing a scene in which a person is present in the target space and an exemplary segment image captured. In FIG. 5A, the person is standing and facing a side with respect to the object information generation system 1, and extending both arms. The object information generation unit 22 calculates a distance by using two different windows WD1 and WD2 as shown in FIG. 5B and Equation (3). For example, a first window WD1 is set to be equal to the circumscribed rectangle of the image of the object (2Δu1 wide and 2Δv1 high), and a second window WD2 is set to be smaller than the image of the object and cut out a portion near the center of the image of the object (2Δu2 wide and 2Δv2 high). The first window WD1 is an exemplary window including the entire object region, and the second window WD2 is an exemplary window including a part of the object region.

If the object (a person in this case) has a shape protruding towards the object information generation system 1, the first window WD1 includes more pixels with greater distance values than the second window WD2. Therefore, a distance dl calculated by using the first window WD1 is greater than a distance d2 calculated by using the second window WD2. The object information generation unit 22 sets a predetermined positive threshold Th_{cv} and determines that an object in a range of Th_{cv}<d1−d2 has a protruding shape. Similarly, another predetermined positive threshold value Th_{cc} is set, and an object in a range of Th_{cc}<d2−d1 is determined to have a recessed shape. When the shape of an object corresponds neither a protruding shape nor a recessed shape, it is determined that the object has a flat surface.

It should be noted, however, that the value of (d1−d2) or the values of d1 and d2, for example, may be generated as the object information, instead of determining which one of the three types of shape the object has as explained above.

### 3. OUTPUT UNIT

The output unit 30 is configured to output object information generated by the object information generation unit 22 to the external device 2. The external device 2 is, for example, a display device such as a liquid crystal display or an organic electro luminescence (EL) display. The output unit 30 causes the external device 2 to display the object information generated by the object information generation unit 22.

Alternatively, the external device 2 may be a computer system including a processor and a memory; the output unit 30 may output the object information generated by the object information generation unit 22 to the external device 2; and further, the external device 2 may use the object information to analyze the shape, position, or motion of the object appearing in the target space.

The external device 2 is not limited to a display device or a computer system as described above and may be another device.

According to the present embodiment described above, the imaging unit 10 in the object information generation system 1 captures a plurality of segment images respectively corresponding to a plurality of distance segments dividing a target space. In the signal processor 20, the object region extraction unit 21 extracts, from a plurality of segment images, an object region that is a pixel region including an image of the object. Then, the object information generation unit 22 determines, for the object region, a window in which calculation-target pixels are cut out, and generates the distance information of the object by calculation using information of a plurality of pixels in the window for two or more segment images. Using the information of the plurality of pixels enables removal of noise, and there is no longer a need to perform measurement a plurality of times for the same pixel to remove the noise. Further, since calculation-target pixels are those in the window determined for the object region, the amount of calculation is significantly reduced as compared to a technique of targeting all the pixels for calculation. Therefore, the distance information can be generated in a short time.

Further, a plurality of different windows may be set for an object region, and the distance information of the object may be generated using each window. This makes it possible to easily obtain distance information of a plurality of locations of the object. Further, information related to the shape of the object may be generated by using the distance information of the object, which information is generated by using the windows.

Further, the distance calculation for the object region may be performed a plurality of times with different conditions. For example, the distance calculation may be performed a plurality of times by changing the number of pixels used for the calculation in the window. Alternatively, the distance calculation may be performed a plurality of times with different shapes of windows.

### 4. OBJECT INFORMATION GENERATION METHOD

Functions similar to those of the object information generation system may be implemented by an object information generation method. The object information generation method obtains information of the distance to an object by the time-of-flight (TOF) method and processes images generated.

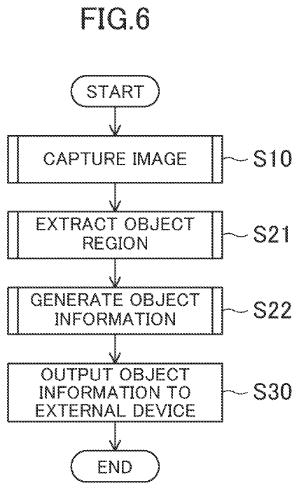

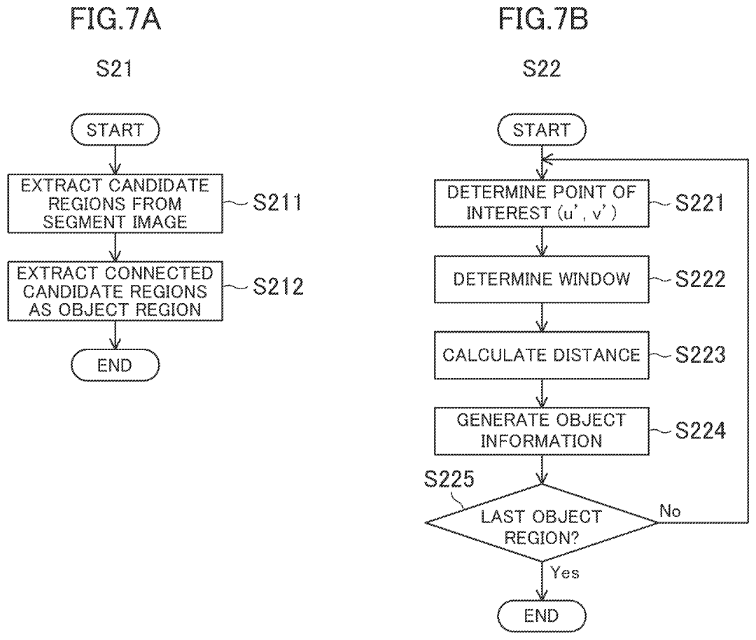

FIG. 6 and FIG. 7 are each a flowchart showing an exemplary object information generation method. In an imaging step S10, a plurality of segment images are generated for each of a plurality of distance segments dividing a target space in a depth direction. In an object region extraction step S21, as shown in FIG. 7A, candidate regions likely to include an image of the object are extracted from each of the segment images (S211), and candidate regions connected are extracted as the object region (S212). In an object information generation step S22 as shown in FIG. 7B, a point of interest is determined for the object region extracted in the object region extraction step S21 (S221); a window including the point of interest and its surrounding is determined (S222); and a distance value is calculated using the pixels in the window (S223). Then, the obtained distance value itself or information related to a characteristic of the object, which is obtained by using the distance value, is generated as object information (S224). The above-described processes are executed for each object region, and when the processes for all the object regions end, the object information generation step S22 ends (S225). The object information generated is output to the external device (S30).

The object information generation method may be implemented as a computer program, a non-transitory recording medium storing a program, or the like. The program causes a computer system to execute an object information generation method.

The object information generation system includes a computer system in the object information generation unit or the like. The computer system includes a processor and a memory as main hardware components. The functions of the object information generation unit and the like are achieved by the processor executing a program recorded in the memory of the computer system. The program may be recorded in advance in the memory of the computer system, may be provided through an electric communication line, or may be provided as a program stored in a non-transitory recording medium readable by a computer system, such as a memory card, an optical disc, or a hard disk drive. The processor of the computer system includes one or more electronic circuits including a semiconductor integrated circuit (IC) or a large-scale integrated circuit (LSI). The plurality of electronic circuits may be integrated into one chip or distributed across a plurality of chips. The plurality of chips may be integrated into one device or distributed across a plurality of devices. The functions as the object information generation system may be achieved by a cloud (cloud computing).

### 5. VARIATIONS

### [5-1. First Variation]

The above-described embodiment deals with a case where object information is generated, assuming that a single object region corresponds to an image of a single object. However, whether it is possible to separate the object region may be determined, considering the possibility that images of a plurality of objects may be in a single object region.

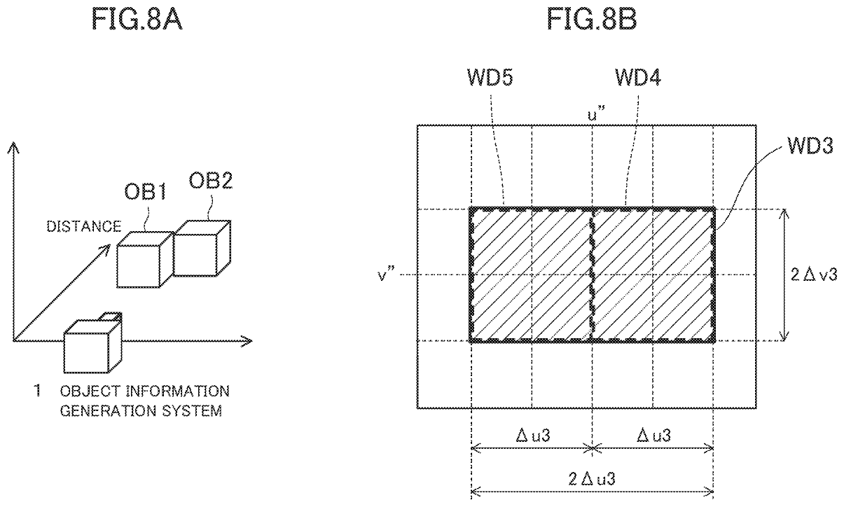

FIG. 8A is a diagram showing a scene in which a plurality of objects are present in a target space, and FIG. 8B is a diagram showing a segment image in which the objects are captured. In FIG. 8A, two objects OB1 and OB2 are arranged in the horizontal direction with respect to the object information generation system 1, and are captured in the same segment image. In FIG. 8B, pixels in a range including images of the two objects OB1 and OB2 are extracted as candidate regions, and the regions are extracted as a single object region, depending on the connectivity of the pixels. In such a case, the object information generation system 1 of the present variation determines whether or not the object region is separable, i.e., whether or not the object region of the objects OB1 and OB2 is separable.

In the present variation, the object information generation unit 22 performs, for each object region, a separability determination process twice, which process determines whether or not the object region is separable. Specifically, the separability determination of the object region is performed once in the horizontal direction and once in the vertical direction.

In the separability determination process, separability determination is performed on the object region in the horizontal direction first. With the center of the circumscribed rectangle (u″, v″) of the object region as the center, a window WD3 (2Δu3 in width and 2Δv3 in height) including the circumscribed rectangle is set. Using Equation (3), the distance dc is calculated, assuming (u′, v′)=(u″, v″) and (Δu, Δv)=(Δu3, Δv3).

Next, with (u″+Δu3/2, v″) as the center, a window WD4 (Δu3 in width and 2Δv3 in height) including the right half of the region in the circumscribed rectangle is set. Using Equation (3), the distance dr is calculated, assuming (u′, v′)=(u″+Δu3/2, v″) and (Δu, Δv)=(Δu3/2, Δv3).

Further, with (u″−Δu3/2, v″) as the center, a window WD5 (Δu3 in width and 2Δv3 in height) including the left half of the region in the circumscribed rectangle is set. Using Equation (3), the distance d1 is calculated, assuming (u′, v′)=(u″−Δu3/2, v″) and (Δu, Δv)=(Δu3/2, Δv3).

In the example of FIG. 8, the object OB2 on the right side of the screen is farther, and the object OB1 on the left side is closer; therefore, the relationship among the calculated distances dc, dr, and dl is:

dl<dc<dr.

In the separability determination process, the object region is determined to be separable in the horizontal direction at u=u″ if (dr−dc)(dc−dl)>0 and if |dr−dl|>Thₛ, where Thₛ is a predetermined threshold value. The object information generation unit 22 generates and outputs object information for each of the left and right objects OB1 and OB2.

The separability in the vertical direction can be determined by applying a process similar to the above-described process to the vertical direction.

For the object region determined to be separable in the separability determination process, the object information generation unit 22 may generate a single piece of object information for the object region, instead of generating object information for each of the objects, and may generate and output information related to the separability as a kind of the object information. Alternatively, separable coordinates may be output.

It should be noted that the number of times the separability determination is performed is not limited to twice, and the determination may be performed once, or three times or more. For example, after determination of the separability in the horizontal direction at u=u″ as described above, a distance drl is calculated in a window cutting out the left half region of the right half region of the circumscribed rectangle, assuming (u′, v′)=(u″+Δu3/4, v″) and (Δu, Δv)=(Δu3/4, Δv3). Similarly, the distance dlr is calculated in a window cutting out the right half region of the left half region of the circumscribed rectangle. The separability may then be determined using the distances drl, dc, and dlr. By repeating this process, it is possible to determine, for example, whether the object has a gentle slope in the horizontal direction or whether there is a step in the depth direction near the center (i.e., a plurality of objects overlap).

Further, there is a possibility that the separable coordinates are not u=u″ if, for example, (dr−dc)(dc−dl)>0 and dr−dl>Thₛ are satisfied and (drl−dc)(dc−dlr)>0 or drl−dlr>Thₛ is not satisfied. Accordingly, such a process may be executed which arbitrarily deforms the window near the center and which closely searches for a separable point. Further, the direction in which the separability is determined is not limited to the horizontal direction or the vertical direction.

Further, the shape and size of the windows in the separability determination process are not limited to those described above.

### [5-2. Second Variation]

In the above-described example, the light receiver 12 is configured to output a plurality of segment images, and the object region extraction unit 21 and the object information generation unit 22 are configured to extract an object region and generate object information by using the segment images. The configuration is not limited thereto: The object information generation system 1 may include an image synthesizer that generates a distance image storing information related to a distance for each pixel by using a plurality of segment images output by the light receiver 12; and the object region extraction unit 21 and the object information generation unit 22 may be configured to extract an object region and generate object information by using the distance image.

The image synthesizer of the present variation calculates, for each pixel, a distance corresponding to a distance segment with a highest signal level and stores the distance as a pixel value of the pixel in the distance image. Alternatively, for example, a process may be executed for each pixel, in which process the distance corresponding to a distance segment with a highest signal level among a plurality of distance segments is stored as a pixel value of the pixel in the distance image, only when the highest signal level is greater than the threshold value Th_{b}, and when the highest signal level among the plurality of distance segments is lower than or equal to Th_{b}, a value indicating that the measurement is invalid is stored.

It should be noted, however, that the method of generating the pixel value of the distance image is not limited to the above. For example, for each pixel, the distance may be calculated in units smaller than the size of the distance segment, by using the distance segment with the highest signal level as basis, based on a ratio between signal levels of its front and rear distance segments, and the obtained distance may be stored as the pixel value of the distance image.

The image synthesizer of the present variation applies the process as described above to all the pixels, and outputs distance images to the object region extraction unit 21.

When pixels in the distance image having the same distance value are connected to each other in any of adjacent eight directions, the object region extraction unit 21 extracts a group of these pixels connected as a single object region. The determination of the connectivity is not limited thereto. For example, pixels may be regarded as being connected if the pixels are connected in any one of four directions, i.e., upward, downward, leftward, and rightward directions, of a pixel of interest. Alternatively, prior to the determination of the connectivity, a binary image storing 1 for pixel coordinates having the same distance value and 0 for the other pixel coordinates may be created. The binary image is pre-processed by using a morphological operation, a median filter, or the like, followed by the determination of the connectivity for the binary image.

The object information generation unit 22 uses the pixel values of the distance images generated by the image synthesizer to further calculate a distance value in the object region in order to generate information related to the three-dimensional position coordinates of the object or the three-dimensional shape of the object or to determine the separability.

For example, when an object region of interest is extracted in the k-th distance segment, the object information generation unit 22 calculates the distance by the following Equation (4), assuming that the center coordinates of the window is (u′, v′) and that the number of pixels indicating a distance equal to dk in the window is Ck.

$$\begin{matrix}[ Math 4 ] & \\ d ( {u}^{′} , {v}^{′} ) = \frac{{\sum }_{n = k - 1}^{k + 1} Ckdk}{{\sum }_{n = k - 1}^{k + 1} Ck} & ( 4 )\end{matrix}$$

The object information generation unit 22 generates information related to the three-dimensional position coordinates of the object or the three-dimensional shape of the object, or generates determination of the separability or the like, by using d(u′, v′).

### INDUSTRIAL APPLICABILITY

The object information generation system according to the present disclosure allows generation of distance information of an object in a short period of time, and is therefore useful in application to, for example, a monitoring camera, a system that analyzes the behavior of a person, a system that detects an obstacle, and the like.

What is claimed is:

1. An object information generation system, comprising:
an imaging unit configured to capture a plurality of segment images respectively corresponding to a plurality of distance segments dividing a target space; and
a signal processor configured to process the plurality of segment images to generate information related to an object present in the target space,
the signal processor including:
an object region extraction unit configured to extract, from the plurality of segment images, an object region that is a pixel region including an image of an object; and
an object information generation unit configured to determine, for the object region, one or more windows in which calculation-target pixels are cut out, and generate distance information of the object by calculation using information of a plurality of pixels in the window for two or more segment images of the plurality of segment images.

2. The object information generation system of claim 1, wherein
the object information generation unit
sets a plurality of the windows different from each other for the object region, and
generates each piece of the distance information of the object by using a respective one of the windows.

3. The object information generation system of claim 2, wherein
the object information generation unit
generates information related to a shape of the object by using each piece of the distance information of the object generated by using a respective one of the windows.

4. The object information generation system of claim 2, wherein
the object information generation unit
determines separability of the object region by using each piece of the distance information of the object generated by using a respective one of the windows.

5. The object information generation system of claim 1, wherein
the object information generation unit
determines the number of pixels for use in the calculation, according to a distance of a distance segment corresponding to a calculation-target segment image.

6. The object information generation system of claim 1, wherein
the signal processor includes
an image synthesizer configured to generate a distance image in which a distance value is assigned to each pixel, by using the plurality of segment images, and
the object region extraction unit extracts the object region from the distance image.

7. The object information generation system of claim 1, wherein
the signal processor includes
an image synthesizer configured to generate a distance image in which a distance value is assigned to each pixel, by using the plurality of segment images, and
the object information generation unit generates the distance information of the object by using the distance image.

8. An object information generation method of generating information related to an object present in a target space by processing a plurality of segment images respectively corresponding to a plurality of distance segments dividing the target space,
the method comprising:
extracting, from the plurality of segment images, an object region that is a pixel region including an image of an object;
determining, for the object region, one or more windows in which calculation-target pixels are cut out; and
generating distance information of the object by calculation using information of a plurality of pixels in the window for two or more segment images of the plurality of segment images.

9. A program that causes a computer system comprising one or more processors to execute the object information generation method of claim 8.
